(19) United States
(12) Patent Application Publication
(10) Pub. No.: US 2010/0293063 A1
(43) Pub. Date: Nov. 18, 2010

(54) SYSTEM AND METHOD FOR APPLYING CONTENT QUALITY CONTROLS TO ONLINE DISPLAY ADVERTISING

(76) Inventors: ANDY ATHERTON, San Francisco, CA (US); Ryan Christensen, San Francisco, CA (US); Aram Compeau, Sunnyvale, CA (US); Madhu Vudali, Santa Clara, CA (US); Kirill Khazanovsky, Cupertino, CA (US)

Correspondence Address: COOLEY LLP;ATTN: Patent Group, Suite 1100, 777 - 6th Street, NW, WASHINGTON, DC, 20001, US

(21) Appl. No.: 12/780,849

(22) Filed: May 14, 2010

Related U.S. Application Data
(60) Provisional application No. 61/178,143, filed on May 14, 2009.

(51) Int. Cl. G06Q 30/00

(52) U.S. Cl. 705/14.73

(57) ABSTRACT

An ad network system for providing content quality controls to advertisers when placing display advertisements online at publishers' sites and applications is disclosed. The ad network system includes a proposal tool for creating proposals for advertising campaigns, the proposals specifying content quality controls for the campaign. An advertiser management system manages the advertising campaigns for the advertisers, and a content categorization module analyzes content at the publishers' sites and applications. The display advertisements are served to the publishers' sites and applications with a two-stage ad server system according to the content quality controls for the advertising campaigns.

### CROSS-REFERENCE TO RELATED APPLICATIONS

This application claims the benefit of to U.S. Provisional Application No. 61/178,143, filed May 14, 2009, entitled “A System and Method for Applying Content quality controls to Online Display Advertising”, which is incorporated herein by reference in its entirety.

### BRIEF DESCRIPTION OF THE INVENTION

This invention relates generally to online display advertising. More particularly, this invention relates to techniques for providing content quality controls to advertisers when placing display advertisements online.

### BACKGROUND OF THE INVENTION

Online display advertising is a popular form of advertising on the Internet that enables advertisers to communicate messages to their target audiences at an affordable cost. The advertiser's messages are communicated online via what's commonly referred to as “display ads”. Display ads may contain text, pictures, audio, video, or a combination of various types of media and interactive content. They may come in many forms and sizes and appear on web pages, search results, e-mails, text messages, online games, social network sites, and a host of other applications.

The multitude of sites on the Internet provides a thriving market for display ads. Participants in the market include advertisers, publishers, and users. The advertisers create the ads (sometimes with help from advertising agencies), and the publishers display the ads—along with content—to the users. By offering content that tends to cater to specific interests and demographics, the publishers enable advertisers to reach their target audience efficiently and effectively.

The advertisers' goal is to deliver a marketing message to their target audience, be it for brand awareness, to develop an emotional connection with the audience, to drive local sales, or for online conversion. For example, a car company may have display ads to build its brand around trust and safety, a pharmaceutical company may have display ads to market a certain drug using patients' stories, and a software company may have a display ad to convert users into buying a particular product.

Publishers, on the other hand, are concerned about growing their user base, page views (such as through repeat visits), and engagement with their users. They do so through organic growth due to their online brand (e.g., popular sites such as CNN.com, NYT.com, facebook, etc.), by producing and publishing original content that attracts users, and by optimizing the placement of their sites in search engine results.

Publishers may also obtain revenue for their content by charging subscription fees to users or offering ad space to advertisers. Ultimately, users want to consume relevant, interesting content, find the information that would help them make a decision, and/or purchase goods and services online. With this in mind, publishers aim to display ads that are relevant and interesting to users and that lead to higher click-through rates, i.e., to higher user clicks on any given ad.

Publishers typically do not serve all the ads to the users themselves, but instead, rely on “advertising networks” to help with monetizing inventory that they cannot sell directly to advertisers. An ad network serves as an intermediary between publishers and advertisers to connect publishers that want to host ads to advertisers who want to run the ads. The ad network buys ad space or inventory from multiple publishers and re-sells them to the advertisers. The inventory may be in the form of “impressions”, which are defined as the display of advertising units on a content requested by a user. Examples of ad networks include Doubleclick.com, Brand.net, and those offered by Google and Yahoo!, among others.

An ad network provides advertisers a “one-stop shop” where they can get the benefits of online display advertising, while avoiding the costs of having to negotiate deals with a large number of publishers individually. The ad network may offer advertisers the ability to run “advertising campaigns” with a guaranteed total number of impressions delivered over a given time period (or “flight”), with a desired mix of different site categories (or “channels”). Examples of typical channels may include “e-mail”, “sports”, and “lifestyles—women”, among others.

The ad network should not only ensure that the contractually guaranteed impression totals are delivered for a given advertising campaign, but also that other advertising campaign constraints specified by the advertisers are observed, including channel mix, smooth pacing or delivery over time, and audience segmentation (or “targeting”). For example, an advertiser may require that impressions (or some fraction of all delivered impressions) be from a given audience segment, e.g., “females—ages 25-44”. The ad network can also add value by ensuring impression delivery, quality standards, and other campaign performance metrics that may be of interest to the advertiser.

A particular concern of an ad network is to ensure that a given advertising campaign is delivered according to the “quality” expectations of the advertiser. Quality in this context refers to whether a publisher's site has objectionable or other type of undesirable content that may cause the user to negatively associate the surrounding content on the site with the brand being advertised in the ad itself.

The notions of quality vary from advertiser to advertiser and from campaign to campaign for a given advertiser. For example, an advertiser running an ad campaign for children's toys may object to seeing its ads displayed on a site with content that is inappropriate for children, whereas the same site may be suitable for an advertiser running an ad campaign to sell wines. In another example, an advertiser running an ad campaign for an oil company may object to seeing its ads displayed on a news site with news on an oil spill. In this case, the content on the site is not objectionable per se, but merely undesirable, as it provides a negative association to the advertiser.

Further complicating the problem is the fact that many publishers vary in the amount of control they exercise on the content that appears on their sites. On one end of the spectrum are professionally edited publisher sites (e.g., CNN.com, NYT.com) which make sure that content is edited or moderated. On the other end are sites which have user-generated content (“UGC”) with minimal to no editorial control. Of course, there are many sites that have a mixture of professionally edited/moderated and UGC. And although professionally edited does not necessarily mean that there are no quality concerns or that UGC sites are always low quality, the level of control exercised on any given site is indicative of the potential risk that advertisers are taking—on professionally edited sites the risk is lower compared to un-moderated UGC sites.

Another complication arises from the fact that the primary technology adopted by ad networks to serve ads is based on inline frames (“iFrames”). iFrames are HTML structures that allow another document, such as a display ad, to be inserted into a web page (e.g., a page at a publisher's site). The use of iFrames is adopted, for example, by Google's AdSense network to serve display ads for their advertisers. The problem with iFrames is that they do not have any direct connection to the content displayed on the page, making it difficult for the ad network to guarantee to advertisers any level of content quality control or relevancy to the placement of their ads.

In practice, because an ad network is an intermediary and typically does not have full control or knowledge of content in the publisher sites and applications on which a given ad is served, ensuring quality becomes a challenge. And, as content changes frequently, the ad network has difficulty staying current on its quality assessment of the sites and pages where its ads are served.

Accordingly, it would be desirable to provide a system and method for ad networks to ensure content quality controls to advertisers when placing display ads on publishers' sites and applications online.

### SUMMARY

An ad network system provides content quality controls to advertisers when placing display advertisements online at publishers' sites and applications. A proposal tool creates proposals for advertising campaigns, the proposals specifying content quality controls for the campaigns. An advertiser management system manages the advertising campaigns for the advertisers. A content categorization module analyzes content at the publishers' sites and applications. A two-stage ad server system serves the display advertisements to the publishers' sites and applications according to the content quality controls for the campaigns.

An embodiment of the invention includes a method for applying content quality controls to display advertisements offered by advertisers at publishers' sites and applications. The publishers' sites and applications are adaptively and asynchronously scanned to monitor their content. The content is analyzed to determine if objectionable or other type of undesirable content that may cause the user to negatively associate the surrounding content on the site with the brand being advertised in the ad itself is present.

Content quality control grades are assigned to the publishers' sites and applications based on their content. The display advertisements are served to the publishers' sites and applications in two stages, with a first stage for determining which advertisements can be served based on the content quality control grades assigned to the publishers' sites and applications and a second stage for selecting and serving an advertisement from an advertising campaign.

Another embodiment of the invention includes a two-stage ad serving system for serving display advertisements online. A first stage ad server has executable routines to receive an ad call from a publisher's page, the ad call having an associated ad tag specifying a content quality control grade for the page, analyze the page to determine whether it contains objectionable or other undesirable content, and modify the ad tag based on the analysis of the page, the modified ad tag specifying eligible advertising campaigns for serving an advertisement to the publisher's page. A second stage ad server selects and serves an advertisement to the publisher's page from an advertisement campaign based on the modified ad tag.

### BRIEF DESCRIPTION OF THE DRAWINGS

Embodiments of the invention are more fully appreciated in connection with the following detailed description taken in conjunction with the accompanying drawings, in which like reference characters refer to like parts throughout, and in which:

FIG. 1 illustrates an exemplary environment in which an ad network operates;

FIG. 2 illustrates a more detailed ecosystem in which an ad network operates in accordance with an embodiment of the invention;

FIG. 3 illustrates a flow chart characterizing the management of advertising campaigns in the ad network of FIG. 2 in accordance with an embodiment of the invention;

FIG. 4 illustrates a flow chart for setting up a campaign in the Pre-Campaign Set-Up Stage of FIG. 3 in accordance with an embodiment of the invention;

FIG. 5 illustrates a flow chart for proposing a campaign in the Campaign Proposal Stage of FIG. 3 in accordance with an embodiment of the invention;

FIG. 6 illustrates a flow chart for delivering ads to a campaign in the Ad Delivery Stage of FIG. 3 in accordance with an embodiment of the invention;

FIG. 7 illustrates an exemplary report prepared during the Post-Delivery Stage of FIG. 3 for the ad network of FIG. 2 in accordance with an embodiment of the invention;

FIG. 8 illustrates various deployment modes of the ad network in FIG. 2 in accordance with an embodiment of the invention; and

FIG. 9 illustrates a computer system for implementing the embodiments of the invention.

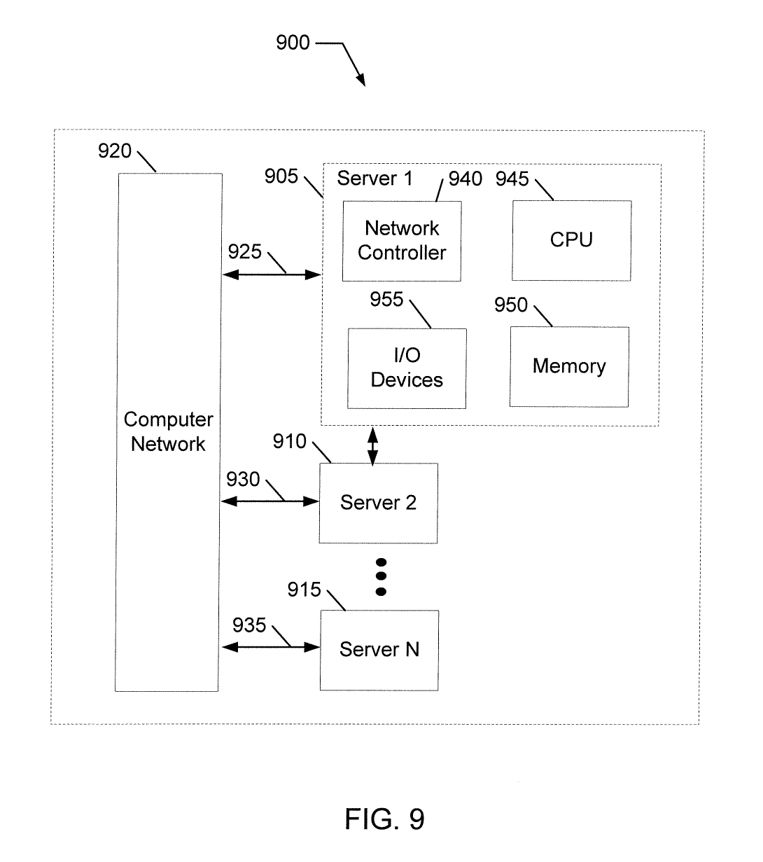

### DETAILED DESCRIPTION

A system and method for providing content quality controls to advertisers when placing display advertisements online are provided. As generally used herein, a display advertisement or “display ad” may be any ad containing text, pictures, audio, video, or a combination of various types of media and interactive content for online display. Display ads may have many forms and sizes and appear on various sites and applications, such as web pages, search results, e-mails, text messages, online games, social network sites, and a host of other applications. The ads are created by advertisers, and publishers display the ads—along with content—to users.

According to an embodiment of the invention, an ad network serves display ads to the publishers to satisfy one or more advertisement campaigns for one or more advertisers. The advertisement campaigns are specified by a set of guarantees delivered over a given period of time (or “flight”) and subject to a set of qualifiers, constraints, and content quality control grades imposed by the advertisers. The guarantees may include a total number of impressions during the flight period or any other performance metric for delivering ads that may be of interest to the advertisers. An impression, as generally referred to herein, is the display of an ad to a user in a publisher's site or application.

Campaign qualifiers may include any designation that describes or qualify the ads in the campaign, such as, for example, the type of product advertised, a price for the product, an age-specific recommendation for the product, a gender recommendation for the product, and so on. Campaign constraints may include a specified set of channels, audience segment, geographic segment, and so on.

In one embodiment, the content quality control grades enable advertisers to select their risk tolerance to objectionable or other type of undesirable content that may cause the user to negatively associate the surrounding content on the site with the brand being advertised in the ad itself. They may be based on any set of attributes for the content, which when evaluated, capture the level of risk of a given publisher's site or application to the advertiser. The content quality control grades are assigned to a given publisher's site or application after an extensive analysis and filtering of the content therein.

As described in more detail herein below, ads are served in two stages. The first stage is dedicated to applying the content quality controls to the publisher's site or application requesting an ad. The second stage determines which advertisement campaign to use for serving the ad based on the campaign constraints, qualifiers, and content quality controls.

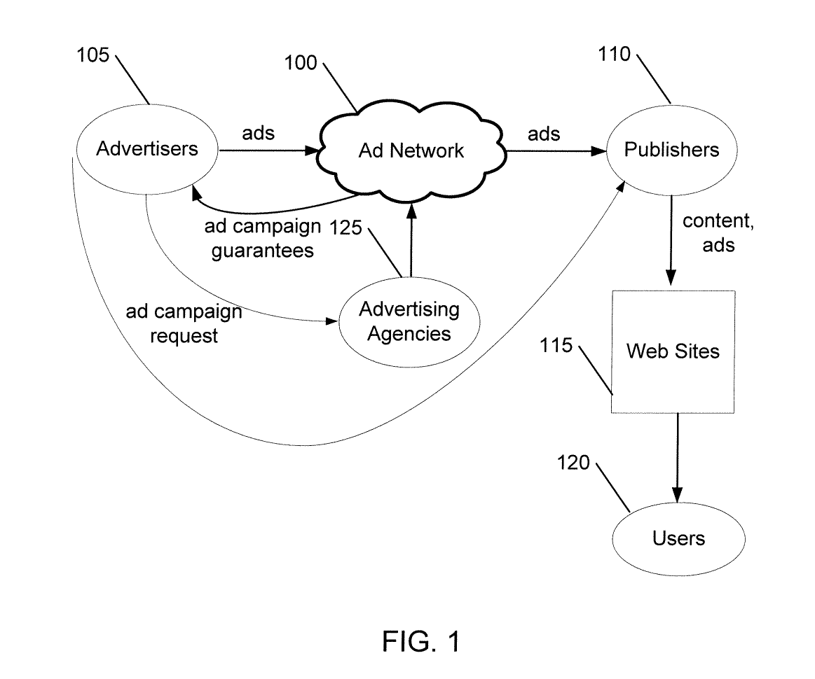

Referring now to FIG. 1, an exemplary environment in which an ad network operates is described. Ad network system 100 is an intermediary network between a set of advertisers 105 and a set of publishers 110. Advertisers 105 engage ad network system 100 to run advertisement campaigns online by serving display ads to sites and applications operated by publishers 110, such as web pages (e.g., web pages 115), search engines, e-mails, text messages, online games, social network sites, and so on, that are viewed by users 120. Advertisers 105 may create the ads themselves and provide them to ad network system 100, or they may interact with one or more advertising agencies 125 to manage their advertisement campaigns and create ads that most effectively achieve their marketing goals.

When advertisers 105 engage ad network system 100 to run their advertisement campaigns, advertisers 105 may require ad network system 100 to abide by a set of campaign guarantees. Such guarantees may include, for example, a total number of impressions (or other performance metric) delivered over a flight period, with a desired mix of channels, with a specified pacing of delivery during the flight period, and for a particular audience segment. Advertisers 105 may also require that ad network system 100 run their advertisement campaigns according to a set of campaign qualifiers, constraints, and content quality controls.

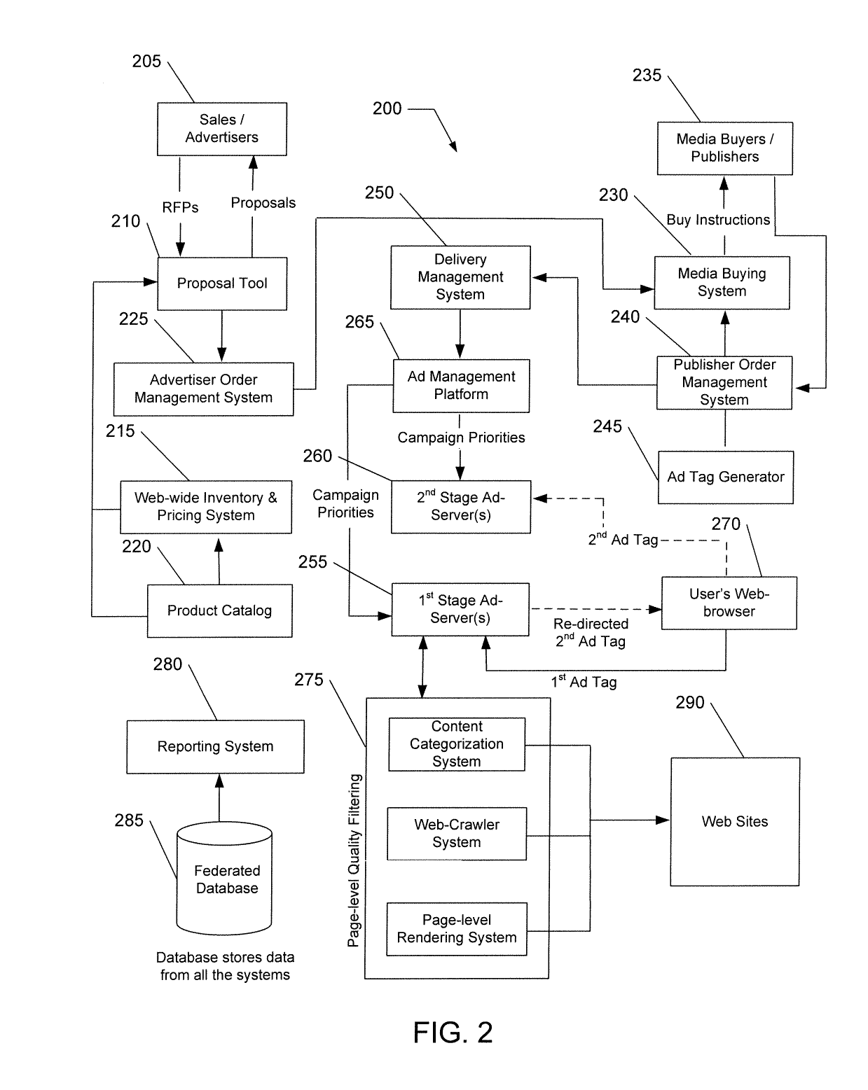

FIG. 2 illustrates a more detailed ecosystem in which an ad network operates in accordance with an embodiment of the invention. Advertisers 205 may submit requests for proposals, or “RFPs”, to ad network system 200 to run one or more advertising campaigns for them. The RFPs are sent to Proposal Tool 210, which is a special purpose computer server for creating proposals for advertisement campaigns. Proposal tool 210 submits the proposals to advertisers 205, specifying to advertisers 205 the campaign guarantees, constraints, and content quality controls for each campaign.

In doing so, Proposal Tool 210 also checks Inventory and Pricing System 215 to forecast the availability of inventory (i.e., impressions on publisher's sites and applications) and an appropriate pricing structure for fulfilling a given advertising proposal. The inventory and pricing forecast is determined based on the content quality controls specified in the proposal for the campaign and according to Product Catalog 220, which defines the ads being sold by ad network system 200 to advertisers 205, specifying the available channels, the targeting criteria (e.g., demographic, geographic, and temporal), as well as the sizes (e.g., 728×900, 300×250 etc.) and formats (e.g., standard, rich media, video) of the ads. As understood by those skilled in the art, the pricing structure may be based on measures such as cost per impression (e.g., cost per a thousand impressions, or “CPM”), cost per click through, cost per action, cost per sale, or any other online advertising pricing model.

The advertising campaigns are managed by Advertiser Order Management System 225, which is a special purpose computer server for managing the campaigns during their delivery to publishers. All campaign qualifiers, constraints, and content quality control grades, to be described in more detail herein below, are stored and maintained in this system.

Once a proposal is established for a given advertising campaign, ad network system 200, through Media Buying System 230, makes optimized purchases of ad inventory, i.e., impressions, from publishers 235. The process for optimizing inventory purchases is the subject of the commonly owned, related patent application entitled “System and Method for Optimizing Purchase of Inventory for Online Display Advertising”, filed the same day as the present application, application Ser. No. ______, Attorney Docket No BRAN-002/01US, the contents of which are hereby incorporated by reference.

Media Buying System 230 sends purchasing instructions to publishers 235, which then engage Publisher Order Management System 240 in ad network system 200 to manage the inventory purchases. As understood by one skilled in the art, each impression has an “ad tag” associated with it. Ad tags are, as generally used herein, small pieces of computer code, usually written in HTML, that ad network system 200 gives to publishers 235. When a user comes to a publisher's web page or application and clicks a given ad impression, the ad tag directs the user's browser to ad network system 200 to retrieve the body of the advertisement. Ad tags are generated by ad network system 200 in Ad Tag Generator 245.

The delivery of the inventory to ad network system 200 is managed by Delivery Management System 250, which maps the impressions sold by publishers 235 to ad servers in ad network system 200 that serve the ads to be displayed in the impressions. Delivery Management System 250 controls the delivery of inventory to ad network system 200 in order to meet the advertising campaign guarantees subject to its constraints, qualifiers, and guarantees, in an optimal manner. Delivery Management System 250 is the subject of the commonly owned, related patent application entitled “System for Optimizing Delivery for Online Display Advertising”, filed the same day as the present application, application Ser. No. ______, Attorney Docket No. BRAN-001/01US, the contents of which are hereby incorporated by reference.

In accordance with an embodiment of the invention and as described in more detail herein below, ads are served by ad network system 200 in two stages, with two dedicated ad servers. Alternatively, the functionality of serving the ads can be incorporated within one or more servers. The first stage is handled by First Stage Ad Server 255, and the second stage is handled by Second Stage Ad Server 260. Second Stage Ad Server 260 may also interact with a third-party Ad Management Platform 265 when serving the ads, such as the Doubleclick.com or Adtech.com platforms.

First Stage Ad Server 255 applies the content quality controls of the advertising campaigns before instructing Second Stage Ad Server 260 to serve the ads. An ad is served once a user places an ad call or ad request on a publisher's application, e.g., IM, e-mail, search engine, etc., or on a web browser, such as User's Web Browser 270. The ad call is sent to First Stage Ad Server 255, with an ad tag that carries the primary information about the inventory on which some campaigns can run, including targeting details, ad size, and a default control grade assigned to the publisher's web page or application from where the ad call originated. The ad call also carries the “referrer” (e.g., referring URL or refURL) of the web page that has made the ad call.

Upon receiving the ad call, First Stage Ad Server 255 sends the content of the page for analysis to Page-Level Content Categorization Module 275, which, as described in more detail herein below, analyzes the page to determine whether it contains any objectionable or undesirable content. First Stage Ad Server 255 then formats an appropriate response in a re-directed ad tag back to the publisher's page or application. The re-directed ad tag is then sent to Second Stage Ad Server 260 for serving an ad, subject to the advertising campaigns' qualifiers, constraints, and control grades maintained in Advertiser Order Management System 225 to determine which of the eligible campaigns can serve the ad. In doing so, Second Stage Ad Server 260 may interact with a third-party ad serving system such as Doubleclick.com or Adtech.com.

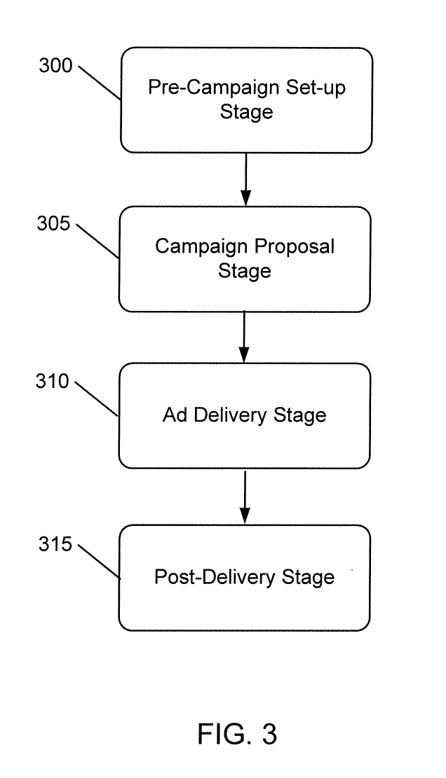

Referring now to FIG. 3, a flow chart characterizing the management of advertising campaigns in ad network system 200 in accordance with an embodiment of the invention is described. Ad network system 200 manages advertising campaigns for advertisers 205 in four stages: (1) Pre-Campaign Set-Up Stage 300; (2) Campaign Proposal Stage 305; (3) Ad Delivery Stage 310; and (4) Post-Delivery Stage 315. Each stage is described in more detail herein below.

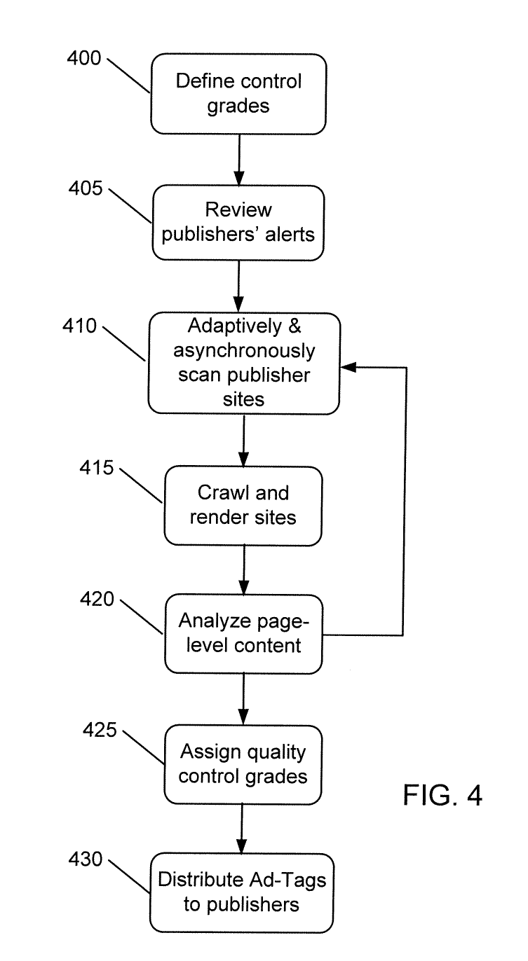

Pre-Campaign Set-Up Stage 300, for setting up a campaign in accordance with an embodiment of the invention, is illustrated in a flow chart in FIG. 4. Pre-Campaign Set-Up Stage 300 starts by defining a set of content quality control grades that advertisers 205 can use to qualify their advertising campaigns (400). An exemplary set of content quality control grades in accordance with an embodiment of the invention is shown in Table 1. The content quality control grades enable advertisers 205 to select their risk tolerance to objectionable or other type of undesirable content that may cause the user to negatively associate the surrounding content on the site with the brand being advertised in the ad itself. The content quality control gradescan be based on any set of content attributes, which when evaluated, capture the level of risk to advertisers 205. Further, the set of attributes can be chosen such that content quality control grades can be determined dynamically during the page-level content analysis and categorization described below (420).

TABLE 1
Content quality control Grades

| Control Grade | Definition |
|---|---|
| Grade 1 | Professional and editorial content only |
| Grade 2 | Professional content and editorial with moderated user-generated content |
| | (“UGC”); no objectionable or undesirable content found; may include |
| | peer-to-peer communication, such as mail and ecards, which are not |
| | moderated. |
| Grade 3 | Professional content and editorial with moderated/un-moderated UGC; |
| | moderately objectionable or undesirable content found primarily on areas |
| | not adjacent to ads (e.g. below-the-fold article comments) or on pages that |
| | don't include Brand.net ads (e.g. publisher does not run on ads on UGC |
| | pages or has scheduled Brand.net ads away from these pages); may include |
| | peer-to-peer communication, such as mail and ecards, which are not |
| | moderated. |
| Grade 4 | Professional content and editorial with moderated/un-moderated UGC; |
| | moderately objectionable or undesirable content found and may be |
| | adjacent to ads; may include peer-to-peer communication, such as mail and |
| | ecards, which are not moderated. |
| Grade 5 | Un-moderated UGC on highly dynamic content; objectionable or |
| | undesirable content possible; includes peer-to-peer communication, such |
| | as mail and ecards. |

It is appreciated that there is an ordinal ranking of the content quality control grades. Grade 1 is better than Grade 2, Grade 2 is better than Grade 3, and so on. This allows ad network system 200 to be flexible and provide advertisers 205 with inventory that is at least of the control grade that they desire, e.g., if an advertiser chooses Grade 3, then ad network system 200 can serve it with inventory from Grades 1 and 2, if available.

After specifying the content quality control grades to be used in its advertising campaigns, ad network system 200 proceeds to review publishers' alerts (405). Each publisher has some resident code provided by ad network system 200 that is integrated with its content management system. The resident code alerts ad network system 200 when there variety of data, including the URL of a given page and the date/time on which content on the page has changed.

Each publisher's site/page and application is scanned for objectionable or undesirable keywords in an adaptive and asynchronous manner (410). The frequency of scanning a given publisher's site/page or application depends on its underlying content. The more dynamic the underlying content, the more frequent the scan. A time-to-live (“TTL”) parameter is assigned to each page and application that is set when a decision about the page's content is made below. When the TTL has expired, it is time to update the decision. It is appreciated that the TTL for each site/page and application is variable. It is also appreciated that ad network system 200 monitors changes in content to adjust the TTL, so that scanning is adaptive.

Ad network system 200 maintains a list of publishers' sites and applications on which advertisers 205 expect it to run their advertising campaigns. All sites and applications on the list are crawled by ad network system 200 (415). The objective of the crawling is to collect all web pages on a given publisher's site and uniquely identify them by their URL. This unique identifier is used in reference to the page as well as to potentially tie an ad call to a page on a publisher's site. Once a page has been crawled, the page is graphically rendered (415). All text and images, including the page-level layout details are captured for further analysis by Page-Level Content Categorization Module 275.

Page-Level Content Categorization Module 275 analyzes a page's content to determine both the content/semantics of the page and what, if any, objectionable or undesirable content, including profanity, is present (420). First, the content on the page is analyzed to determine all relevant categories. For example, the site http://www.ufc.com (a site for Ultimate Fighting) can be classified into “Sports” and “Violence” categories. Each page analyzed is tagged with all content categories that are identified thereon. Pages with objectionable or undesirable content are ineligible for serving advertising campaigns and Public Service Ads (“PSAs”) are served in those cases. It is appreciated that the decision to serve PSAs is a business policy decision and may be optional. Alternatively, other ads may be served in their place.

In performing this content analysis, Page-Level Content Categorization Module 275 has a list of objectionable and undesirable content categories available. For example, Page-Level Content Categorization Module 275 may have a profanity list with words that, if present on a page, immediately disqualifies the page from getting any advertising campaigns. To determine whether that is the case, the content on a page is parsed or scanned to find any matches in the profanity list, including whole word matches, exact matches, case-insensitive matches, and any obfuscations, such as regular and other expressions.

Page-Level Content Categorization Module 275 also scans the page for objectionable and undesirable keywords (410) since certain advertisers may be sensitive about some specific keywords appearing next to their ads, e.g., an advertiser for peanut butter may object to the word “salmonella” on its page. A list of objectionable and undesirable keywords is kept for each advertiser campaign run by ad network system 200. Instead of only showing PSAs on pages with matches, ad network system 200 just blocks the sensitive advertisers from the page. An ad cannot be shown on a page if either the content category is objectionable or undesirable, or if there are objectionable or undesirable keywords on the page.

It is appreciated that the crawling (415) and scanning (410) are done asynchronously from ad calls. Essentially, when First Stage Ad Server 255 queries the Page-Level Content Categorization Module 275, the last known status of the page is returned. This is done asynchronously in order to minimize the latency of responding to User's Browser 270.

Page-Level Content Categorization Module 275 then assigns a content quality control grade to a page after it is scanned and its content analyzed (425). For all the publisher sites and applications in the list crawled by ad network system 200, content quality control grades are assigned based on a set of criteria, including: the presence of objectionable or other type of undesirable content that may cause the user to negatively associate the surrounding content on the site with the brand being advertised in the ad itself, the type of objectionable or undesirable content (e.g., profanity, illegal drugs, death, etc.), the location of the objectionable or undesirable content (e.g., in the editorial content, in the UGC, or “below the fold”), the type of UGC (e.g., community/message board, article comments, video/photo upload), moderation of UGC, and peer-to-peer content.

All the sites and applications on the list are audited periodically to score them according to these criteria. Control grade assignment can also be triggered when content change alerts are received from publishers. Depending on the definition of the content quality control grades, the assignment of control grades can be done dynamically during the page-level content analysis (420).

After assigning control grades to the publishers' sites and applications, ad network system 200 distributes ad tags to publishers 235 (430). The ad tags carry information about the content quality control grade of each site and application, along with other standard descriptors, such as ad-size, demographics, and so on. By inserting the content quality control grades in the ad-tags, ad network system 200 is able to know the control grade of a given page or application at the time of ad-serving so that advertiser campaigns can be targeted more appropriately.

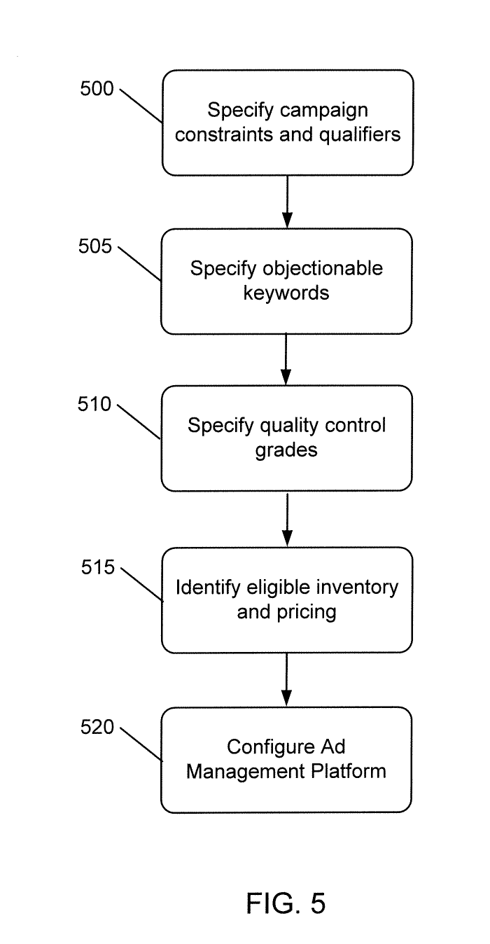

Referring now to FIG. 5, a flow chart for proposing a campaign in Campaign Proposal Stage 305 in accordance with an embodiment of the invention is described. First, advertisers choose the channels, targeting, and flight period for each campaign to be run in ad network system 200 (500). The set of channels chosen for a given campaign determines the publishers' sites and applications on which the campaign ads appear.

Next, any keyword that advertisers want to be added to the objectionable and undesirable keyword list kept by ad network system 200 is added with the campaign qualifiers (505). In addition, the advertiser chooses the content quality control grades that is most appropriate for their campaigns (510). The selected content quality control grades determine the qualifying sites for each campaign. Since content quality control grades have an ordinal ranking, the eligible publishers' sites and applications for the campaign are all those that are at or above a given control grade. As described above with reference to FIG. 2, all campaign qualifiers and constraints are stored and maintained in Advertiser Order Management System 225.

Once the campaign qualifiers and constraints are specified, the available inventory and pricing for the campaign can be identified (515). The inventory for a given campaign is the sum of all available inventory for the eligible (i.e., qualifying) sites and applications. Similarly, the pricing for a given campaign is determined as the weighted average of the underlying site-level prices of all eligible sites and applications.

Lastly, the use of content quality control grades requires that Ad Management Platform 265 be configured to apply them to the advertising campaigns (520). Campaigns are set up in Ad Management Platform 265 to manage the ad delivery process. Content quality control grades are similar to targeting attributes (e.g., Gender=“Female”) when entered into Delivery Management System 250, thereby allowing ad network system 200 and Ad Management Platform 265 to accurately target ad delivery to the advertising campaigns. It is appreciated that the ordinal ranking of the content quality control grades implies that the targeting is expressed as a logical OR constraint. That is, if the chosen content quality control grade is 2, then the targeting constraint is specified as “control grade=1 or control grade=2”.

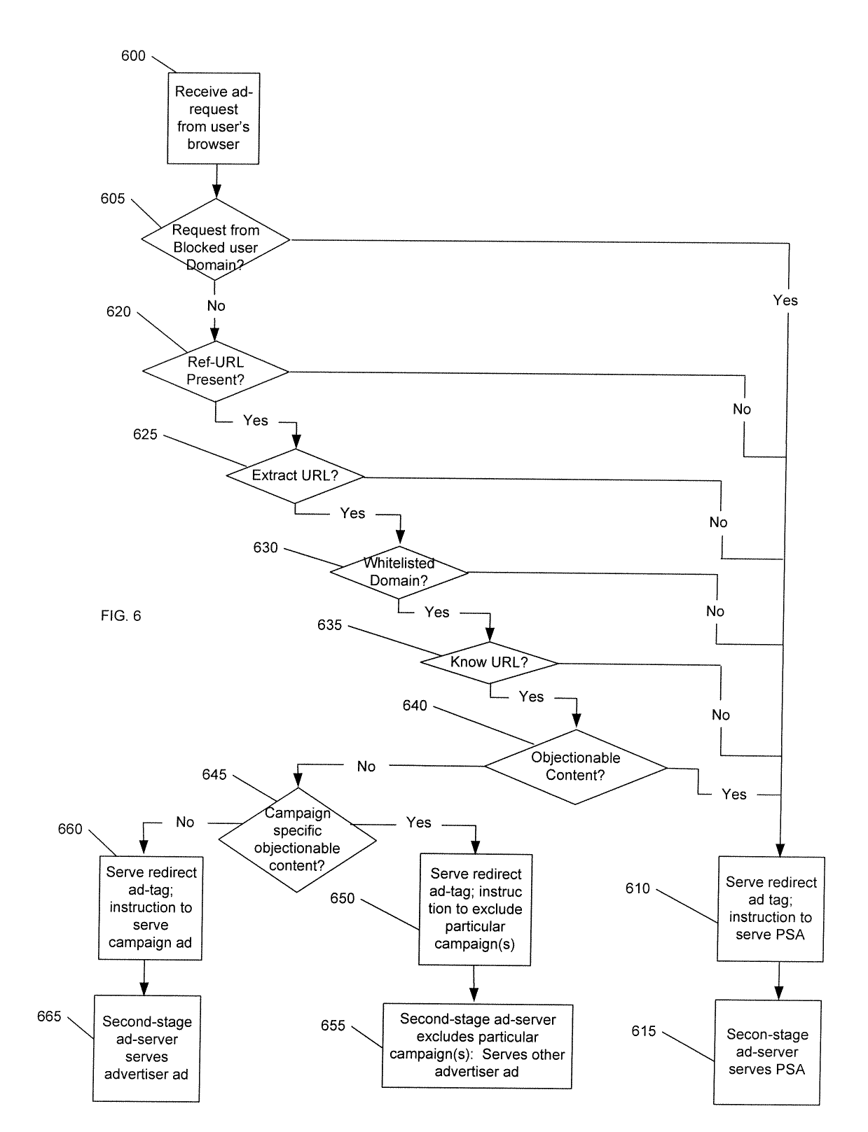

Referring now to FIG. 6, a flow chart for delivering ads to a campaign in Ad Delivery Stage 310 in accordance with an embodiment of the invention is described. As described above, ads are served in two stages by two servers. In the first stage, First Stage Ad Server 255 applies content quality controls to ensure that advertisers' campaigns can be served for the impression associated with an incoming ad call. In the second-stage, Second Stage Ad Server 260 serves an ad from any of the eligible campaigns for that impression. It is appreciated that there may be more than one First Stage Ad Server and more than one Second Stage Ad Server, each independently processing ad calls as they come.

Incoming ad calls are received from a publisher's site or application running in User's Browser 270 by First Stage Ad Server 255 (600). Each ad call carries information about the inventory on which the advertising campaigns can run, including, for example, targeting details, ad size, and the content quality control grade assigned to the publisher's site or application from which the ad call originated. The ad call also carries the “referrer” (e.g., referring URL or refURL), of the publisher's page that has made the ad call. It is appreciated that if the ad call originates from a publisher's application, such as IM, another referrer can be used to identify the ad call's origin.

First Stage Ad Server 255 then checks the domain from which the ad call is made. Certain domains are classified as domains blocked from receiving ads, e.g., to minimize fraud. In this case, if the requesting domain is a blocked domain (605), then First Stage Ad Server 255 requests that a PSA be served by issuing a re-directed ad tag to the publisher's site or application (610) to instruct Second Stage Ad Server 260 to serve the PSA ad (615). It is appreciated that there may be more than one classification of domains by which the First Stage Ad Server decision are made. It is appreciated that the decision to serve PSAs is a business policy decision and may be optional. Alternatively, other ads may be served in their place.

Otherwise, if the domain is not blocked, First Stage Ad Server 255 checks to see if the URL of the publisher's page (or the referrer of the publisher's application) from which the ad call originated is present (620). It is appreciated that the URL that is supplied in the referrer field of an ad call may not be a clean one because of the way an ad-call is coded on the publisher's page, for example, the referrer in the ad call may point to the URL of First Stage Ad Server 255 while the actual URL may be encoded in the ad tag.

First Stage Ad Server 255 then attempts to extract the actual URL using an extraction technique based on what is passed in the ad call (625). The extraction technique may include: (1) Macro-Based Extraction; (2) Encoded-URL Extraction; (3) Crawler-Match Extraction; and (4) Publisher-Assisted Extraction, among others. Macro-Based Extraction can be used when a special-purpose macro is inserted in the ad tag to instruct the publisher's web server or application to pass the URL of the publisher's page in a special field of the ad call. Encoded-URL Extraction can be used to extract an encoded URL from the ad call. The encoding is based on the standard HTML encoding protocol. Crawler-Match Extraction detects whether there is a special identifier in the ad call that ties that ad call to a unique page on the publisher's site. This can be accomplished because the publisher's site is being asynchronously crawled. Lastly, Publisher-Assisted Extraction is used when publishers have publisher-resident technology that passes refURLs to First Stage Ad Server 255.

If a well-formed URL can not be extracted, then First Stage Ad Server 255 cannot verify the content on the page and, therefore, it can only serve PSAs (610, 615). It is appreciated that the decision to serve PSAs is a business policy decision and may be optional. Alternatively, other ads may be served in their place. Otherwise, First Stage Ad Server 255 converts the extracted URL to a canonical form to be used for all downstream references of the URL and verifies that the ad call is from a known publisher domain (630). The URL conversion into a canonical form is done to ensure that URLs that have different syntaxes may still refer to the same page, e.g., http://yahoo.com is the same page as www.yahoo.com. The publisher domain can be determined based on the extracted URL.

Again, if the publisher domain is not on the accepted list of domains, then only PSAs can be served (610, 615). Otherwise, First Stage Ad Server 255 checks whether the URL is in the server's cache (635). If the URL is not in the cache, PSAs are served, and a request to categorize the content on the page is made (610, 615). If the URL is in the cache, then the First Stage Ad Server 255 verifies that the content on the originating page or application is not objectionable or undesirable (640, 645). First Stage Ad Server 255 queries the cache to check if the page referenced by the URL has any objectionable or undesirable content, including any campaign specific objectionable or undesirable keywords. This is done by Page-Level Content Categorization Module 275, as described above. It is appreciated that the decision to serve PSAs is a business policy decision and may be optional. Alternatively, other ads may be served in their place.

If globally objectionable or undesirable content is found, only PSAs can be served (610, 615). If campaign-specific objectionable or undesirable keywords are found, then the campaign's identifier is returned to First Stage Ad Server 255 so that Second Stage Ad Server 260 can exclude the particular campaign and serve an ad from another campaign (650, 655). It is appreciated that the decision to serve PSAs is a business policy decision and may be optional. Alternatively, other ads may be served in their place.

Lastly, if no objectionable or undesirable content or keywords are found, then any eligible advertiser campaign can be served. In this case, First Stage Ad Server 255 then issues a re-directed ad tag and instructs Second Stage Ad Server 260 to serve an ad (660, 665).

The re-directed ad call is sent back to User's Browser 270. The re-directed ad call is essentially a set of instructions to the Second Stage Ad Server 260 regarding the eligible campaigns for that ad request. Second Stage Ad Server 260 applies the usual campaign prioritization rules to determine which of the eligible campaigns can serve the given ad call. It is appreciated that the ad seen by the user on his/her browser is a result of all the preceding content filtering performed by First-Stage Ad Server 255 and Page-Level Content Categorization Module 275. Different levels of page/site quality may yield different ads. It is appreciated that the instructions from the First Stage Ad Server to the Second Stage Ad Server can be rendered via mechanisms other than a re-directed ad tag.

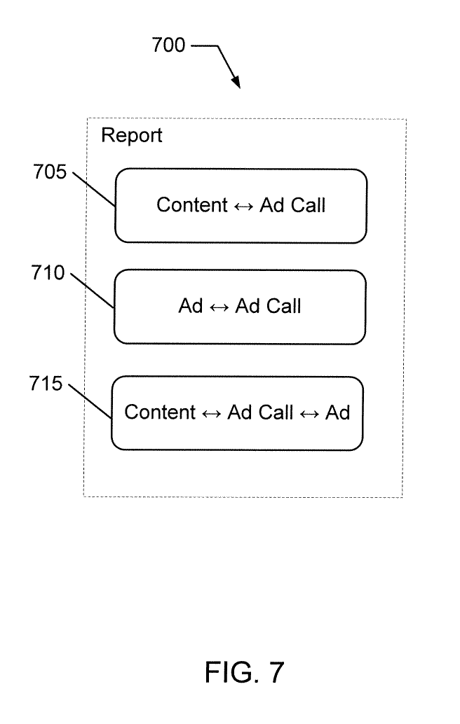

After an ad is served, ad network system 200 can prepare an accountability report to the advertiser offering the ad detailing how the ad campaign qualifiers, constraints, and content quality control grades were met by ad network system 200. An exemplary report prepared during Post-Delivery Stage 315 for ad network system 200 in accordance with an embodiment of the invention is illustrated in FIG. 7. Reporting System 280 (FIG. 2) produces reports to advertisers 205, e.g., Report 700, with data stored in Federated Database 285.

Report 700 contains detailed information about the management of an ad campaign, such as, for example, how a given ad call is tied to the content on the page (705), how a particular advertiser's ad is tied to a given ad call based on the decisions made by First Stage Ad Server 255 and Second Stage Ad Server 260 during the ad serving process (710), and how the content of the page is tied to the ad call and subsequently how the ad call is tied to the served ad (715). This and other additional information is available as a report to all advertisers wanting to audit/verify their content quality controls, campaign qualifiers, and constraints. Further, report 700 may be produced by content quality control grade, that is, ad network system 200 may provide reports showing the delivery of ads across various content quality control grades.

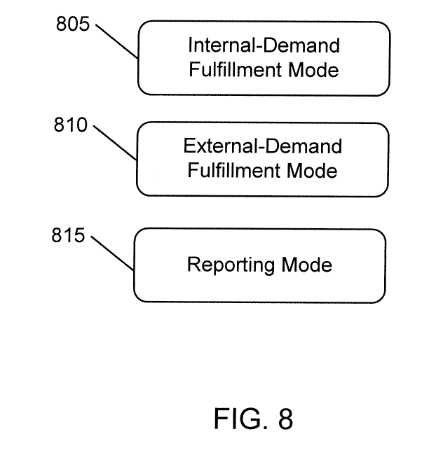

It is appreciated that ad network system 200 may be used in various deployment modes, as illustrated in FIG. 8. Deployment modes 800 include: (1) Internal-Demand Fulfillment Mode 805; (2) External-Demand Fulfillment Mode 810; and (3) Reporting Mode 815. Both External-Demand Fulfillment Mode 810 and Reporting Mode 815 are stand-alone modes.

In Internal-Demand Fulfillment Mode 805, ad network system 200 re-directs the ad-calls to Second Stage Ad Server 260, which in turn is servicing campaigns stored in ad network system 200's own ad management system 225 (rather than using a third-party Ad Management Platform such as Ad Management Platform 265).

In External-Demand Fulfillment Mode 810, ad network system 200 may be used by other advertisers for verifying the content quality controls for their campaigns which are not serviced by ad network 800. In this mode, ad network system 200 can distinguish the ad requests coming from external advertisers from its own ad calls and is able to appropriately format the re-directed ad calls. In this case, ad calls may have additional attributes identifying the source of the request and, hence, the source of demand. First Stage Ad Server 255 may process ad requests differently based on the source of demand.

In Reporting Mode 815, ad network system 200 may be used by an external advertiser to provide reports on the quality of their campaign delivery. In one embodiment, the external advertiser may append a 1×1 invisible pixel to their ad to point to First Stage Ad Server 255 of ad network system 200. First Stage Ad Server 255 then recognizes the request coming from the pixel and does not serve a re-directed ad call. Instead, it performs the usual quality query and records the results for later reporting to the requester.

The ad network systems 200 of FIG. 2 and its components and operations described with reference to FIGS. 3-8 can be implemented using computer system 900. Computer system 900 may include one or more computer servers 905-915 that are connected to computer network 920, e.g., the Internet, via computer buses 925-935. Computer servers 905-915 may be any computer server known to one skilled in the art, and may include components such as network controller 940, CPU 945, memory 950, I/O devices 955 (e.g., keyboard, mouse, touch screen, monitor, printer, and the like, not shown), and so on.

Advantageously, the ad network system of embodiments of the invention enables advertisers to ensure content quality controls when placing display ads on publishers' sites and applications online. In contrast to traditional approaches, content quality control is seamlessly achieved by the ad network while delivering campaign guarantees to multiple campaigns.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications; they thereby enable others skilled in the art to best utilize the invention and various embodiments with various modifications as are suited to the particular use contemplated. It is intended that the following claims and their equivalents define the scope of the invention.

What is claimed is:

1. An ad network system for providing content quality controls to advertisers when placing display advertisements online at publishers' sites and applications, comprising:
a proposal tool to create proposals for advertising campaigns, the proposals specifying content quality controls for the campaigns;
an advertiser management system to manage the advertising campaigns for the advertisers;
a content categorization module to analyze content at the publishers' sites and applications; and
an ad server system to serve the display advertisements to the publishers' sites and applications according to the content quality controls for the campaigns.

2. The ad network system of claim 1, wherein the content quality controls comprise a plurality of content quality control grades for identifying levels of objectionable or undesirable content.

3. The ad network system of claim 1, wherein the proposals further specify guarantees and constraints for the advertising campaigns.

4. The ad network system of claim 3, wherein the guarantees comprise a total number of impressions delivered over a flight period with a desired mix of channels, a specified pacing of delivery, and for a particular audience segment.

5. The ad network system of claim 1, wherein the proposal tool determines inventory and pricing for the advertising campaigns based on the content quality controls.

6. The ad network system of claim 1, wherein the advertiser management system instructs a media buying system to make optimized purchases of inventory from the publishers' sites and applications.

7. The ad network system of claim 1, wherein the content categorization module comprises a web crawling and rendering system to crawl and render the publishers' sites and applications.

8. The ad network system of claim 1, wherein the content categorization module comprises a module to analyze content for objectionable and undesirable categories and keywords.

9. The ad network system of claim 1, wherein the content categorization module is deployed asynchronously to ad calls received from the publishers' sites and applications.

10. The ad network system of claim 1, wherein the content categorization module is adaptive to changes in content in the publishers' sites and applications.

11. The ad network system of claim 1, wherein the ad server system comprises a dedicated first stage ad server to apply content quality controls to the publishers' sites and applications.

12. The ad network system of claim 11, wherein the ad server system comprises a dedicated second stage ad server to serve advertisements to the publishers' sites and applications subject to the application of content quality controls by the first stage ad server.

13. A method for applying content quality controls to display advertisements offered by advertisers at publishers' sites and applications, the method comprising:
in an advertising computer network,
adaptively and asynchronously scanning the publishers' sites and applications to monitor their content;
analyzing the content to determine if objectionable or undesirable content is present;
assigning content quality control grades to the publishers' sites and applications based on their content; and
serving the display advertisements to the publishers' sites and applications in two stages, with a first stage for determining which advertisements can be served based on the content quality control grades assigned to the publishers' sites and applications and a second stage for selecting and serving an advertisement from an advertising campaign.

14. The method of claim 13, further comprising crawling and rendering the publishers' sites and applications.

15. The method of claim 13, wherein analyzing the content comprises analyzing the content in a web page for objectionable or undesirable categories and keywords.

16. The method of claim 13, wherein assigning content quality control grades to the publishers' sites and applications comprises distributing ad tags to the publishers.

17. The method of claim 16, wherein serving the display advertisements to the publishers' sites and applications in two stages comprises receiving the ad tags from the publishers at a first stage ad server and modifying the ad tags to specify the advertisements that can be served subject to the content quality control grades.

18. The method of claim 17, further comprising redirecting the modified ad tags to a second stage ad server for selecting and serving the advertisement from the advertising campaign.

19. A two-stage ad serving system for serving display advertisements online, the system comprising:
a first stage ad server comprising executable routines to:
receive an ad call from a publisher's page, the ad call having an associated ad tag specifying a content quality control grade for the page;
analyze the page to determine whether it contains objectionable or undesirable content; and
modify the ad tag based on the analysis of the page, the modified ad tag specifying eligible advertising campaigns for serving an advertisement to the publisher's page; and
a second stage ad server to select and serve an advertisement to the publisher's page from an advertisement campaign based on the modified ad tag.

20. The two-stage ad serving system of claim 19, wherein the first stage ad server further comprises an executable routine to extract an URL to identify the page.
